(19) United States
(12) Patent Application Publication
(10) Pub. No.: US 2007/0245225 A1
(43) Pub. Date: Oct. 18, 2007

(54) System and method for translating between a global view of a system process and a set of interacting processes

(76) Inventors: Martin P. Nally, Laguna Beach, CA (US); James E. Rumbaugh, Saratoga, CA (US)

Correspondence Address: DILLON & YUDELL LLP, 8911 N. CAPITAL OF TEXAS HWY., SUITE 2110, AUSTIN, TX, 78759, US

(21) Appl. No.: 11/405,874

(22) Filed: Apr. 18, 2006

(51) Int. Cl. G06F 17/00

(52) U.S. Cl. 715/502

(57) ABSTRACT

A method, apparatus, and computer-usable medium for graphically depicting a behavior as a global process flow graph, wherein the global process flow graph includes a collection of actions performed by at least two roles; and transforming the global process flow graph into a collection of local processes, wherein each local process includes all actions performed by exactly one role among the at least two roles.

### BACKGROUND OF THE INVENTION

1. Technical Field

The present invention relates in general to the field of computers and similar technologies, and in particular, to software utilized in this field.

2. Description of the Related Art

A “process flow graph” models real-world or computer-implemented transactions as a collection of actions and flows. However, process flow graphs do not explicitly identify the participant of the transaction that is performing a particular action. Therefore, a transaction may be modeled as a collection of partitioned transactions, where each partitioned transaction explicitly identifies the participant that is performing the partitioned transaction. There is a need for a system and method for transforming a process flow graph to a collection of partitioned transactions.

### SUMMARY OF THE INVENTION

The present invention includes a method, apparatus, and computer-usable medium for graphically depicting a behavior as a global process flow graph, wherein the global process flow graph includes a collection of actions performed by at least two roles; and transforming the global process flow graph into a collection of local processes, wherein each local process includes all the actions performed by exactly one role among said at least two roles.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying figures, wherein:

FIG. 1 illustrates an exemplary process flow graph according to a preferred embodiment of the present invention;

FIG. 2 depicts a collection of actions and synchronizers according to a preferred embodiment of the present invention;

FIG. 3 illustrates an exemplary transaction according to a preferred embodiment of the present invention;

FIG. 4 is a block diagram depicting an exemplary data processing system in which a preferred embodiment of the present invention may be implemented;

FIG. 5 is a high-level logical flowchart diagram illustrating an exemplary method of translating between a global view of a system process and a set of local interacting processes according to a preferred embodiment of the present invention;

FIGS. 6a-b show a flow-chart of steps taken to deploy software capable of executing the steps shown and described in FIG. 5;

FIGS. 7a-c show a flow-chart of steps taken to deploy in a Virtual Private Network (VPN) software that is capable of executing the steps shown and described in FIG. 5;

FIGS. 8a-b show a flow-chart showing steps taken to integrate into a computer system software that is capable of executing the steps shown and described in FIG. 5; and

FIGS. 9a-b show a flow-chart showing steps taken to execute the steps shown and described in FIG. 5 using an on-demand service provider.

### DETAILED DESCRIPTION OF A PREFERRED EMBODIMENT

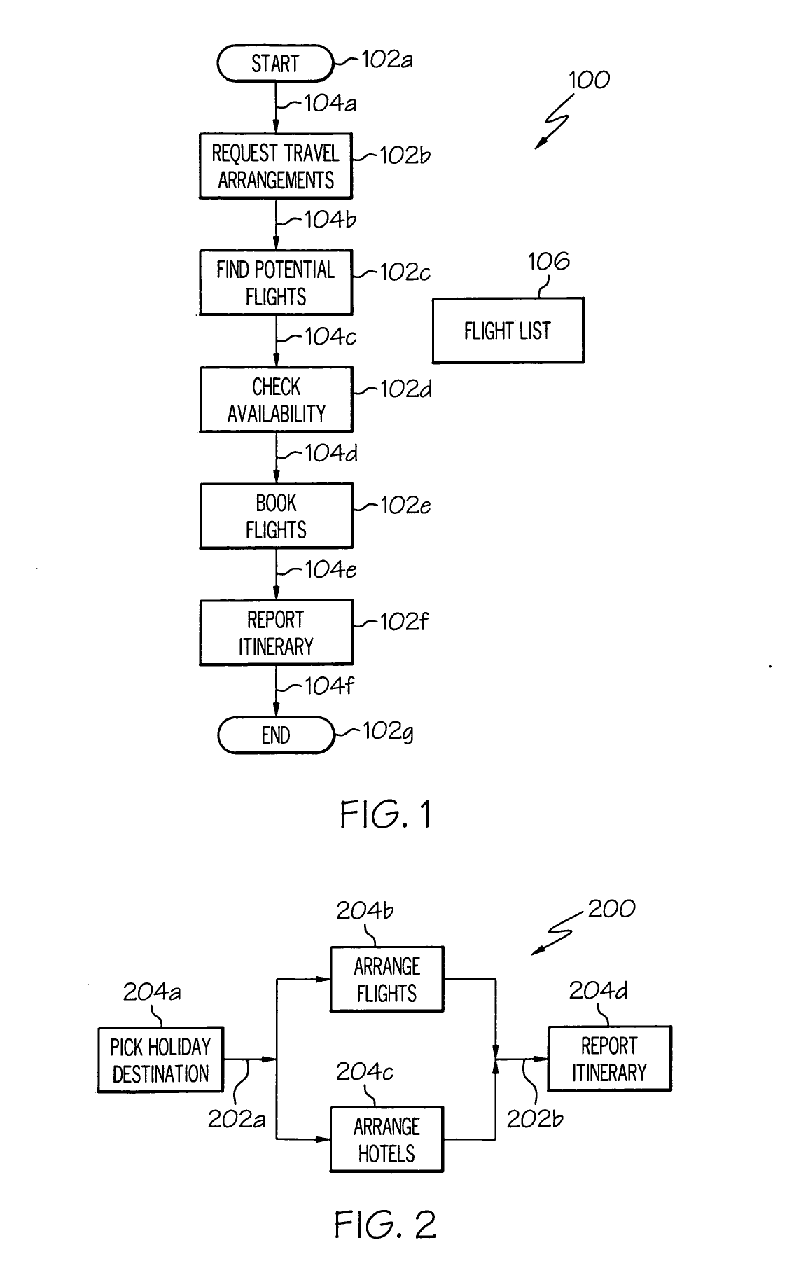

Referring now to the figures, and in particular, referring now to FIG. 1 there is illustrated a process flow graph 100, which depicts a process flow graph for purchasing airline tickets. A “process flow graph” is a model of a real-world or computer-implemented transaction that includes a pattern of behavior described as a network of “actions” (e.g., actions 102a-g) and “flows” (e.g., flows 104a-f). Process flow graph 100 represents a “global view” of the process, which describes an interaction or transaction as a single connected process even though different participants or roles may ultimately perform the various actions. An “action” designates some individual behavior performed by one participant or role in a process flow graph. Each action has one or more input points and one or more output points. The action includes a description of a particular behavior that the action represents.

A “flow” represents a dependency between two actions. A “process” describes the ways in which the behavior represented by the model can be executed. A given process model describes a potentially infinite set of particular executions of the behavior pattern represented by the model.

A progress of a particular execution is marked by some number of “tokens” (e.g., flight list 106) on a copy of the network of actions and flows. A “token” is an indicator of activity. Tokens can be associated with actions and flows and a presence of a token indicates that the progress of execution has reached a given location with the process flow graph.

Initially, a token is placed on a special action with no incoming flow, which represents the initiation of a process (action 102a, which indicates the “start” action). A token present on an action indicates that the behavior represented by the particular action is being executed. When the execution of the action is complete, the token is removed from the action and placed on one of the outgoing flows associated with the completed action.

If the completed action has more than one associated flow, the description in the action specifies how the appropriate flow is chosen based on the parameters and conditions of the appropriate data. An action may begin execution when a token is present on one of its associated incoming flows. When the action begins executions, the token is removed from the incoming flow and placed on the action. The execution of the process is completed when a token is produced on a special action that has no outgoing flows (e.g., action 102g, which indicates the “end” action). This special action represents the completion of the process.

Additionally, certain actions can be designated as “synchronizers”, which require input tokens on each of its associated incoming flows before the synchronizer begins execution. FIG. 2 depicts a process flow graph that includes synchronizers 202a-b and actions 204a-d. Synchronizer 202a is a fork synchronizer and synchronizer 202b is a join synchronizer, which actions 204b-c are performed in parallel.

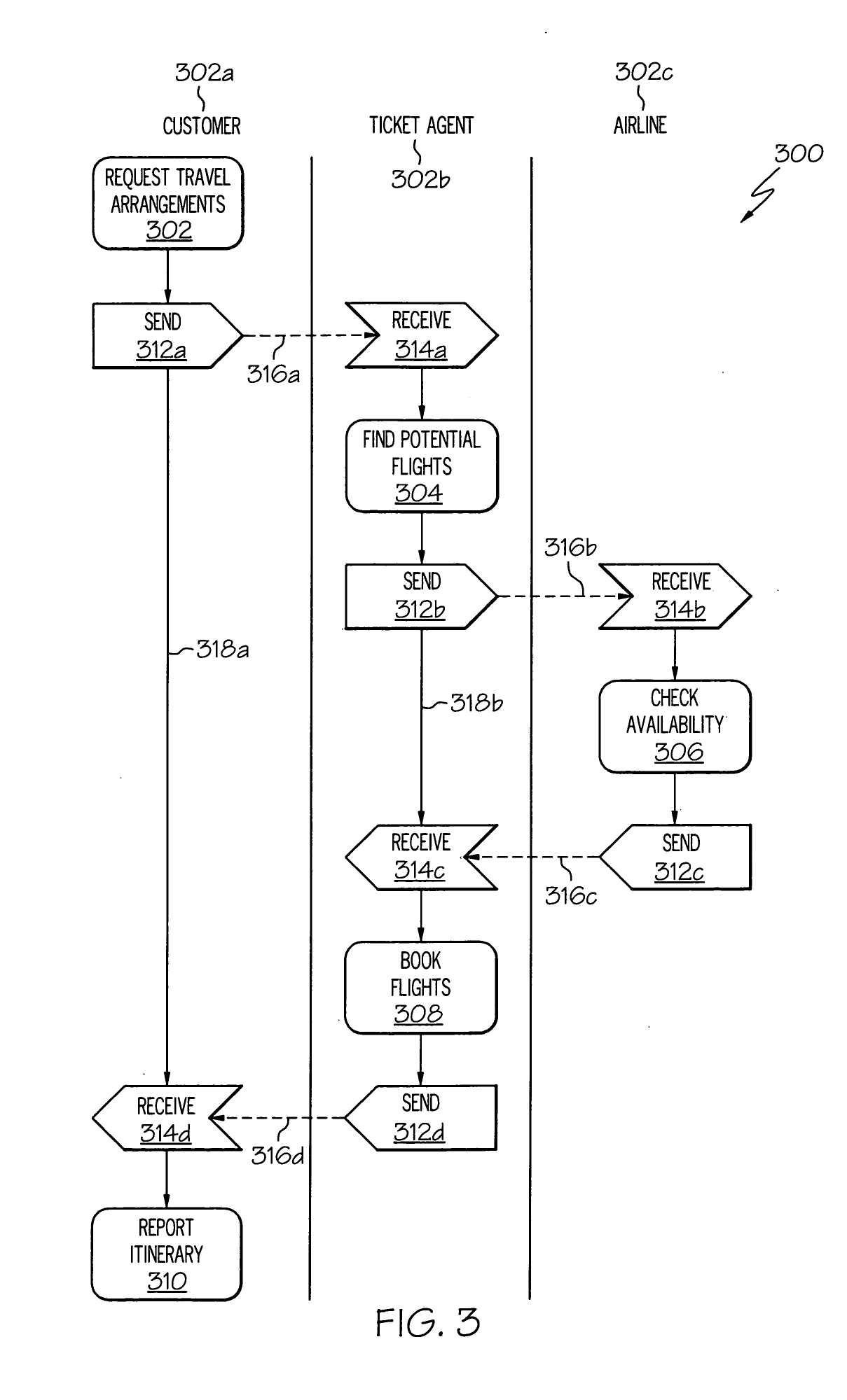

The preceding figures represent a transaction as a single, global process that unifies the entire cause-and-effect chain and is not organized in such a way that clearly identifies the different participants or roles that perform the actions within the process. In the most common implementation, however, execution of a transaction is performed by a number of separate computers or other servers that are connected in some way and that communicate by transmitting messages over the connections. The portion of behavior implemented by each server is called a role and can be represented as a process local to the particular role. In these partitioned transactions, each role has access only to its own behavior and the behavior of other roles is visible only indirectly through messages received from the other roles. FIG. 3 illustrates a transaction 300 (including a collection of processes) that includes roles 302a-c, actions 302-310, send actions 312a-d, and receive actions 314a-d, and messages 316a-d. Each role 302a-c communications with another role via send actions 312a-d, messages 316a-d, and receive actions 314a-d, where the contents of the send and receive actions describe the information to be communicated and the messages indicate the pairings between the send and receive actions. A send action 312a-d indicates a point in a role's behavior where it sends a message 316a-d to another role. Each send action 312a-d obtains its parameters from the preceding action 302, 304, 306 and 308. A receive action 314a-d indicates a point in a role's behavior where it waits for the receipt of a message 316a-d sent by another role. Each receive action 314a-d delivers its results to the succeeding action 304, 306, 308 and 310. Messages 316a-d among send and receive actions in different processes indicate potential communication between roles.

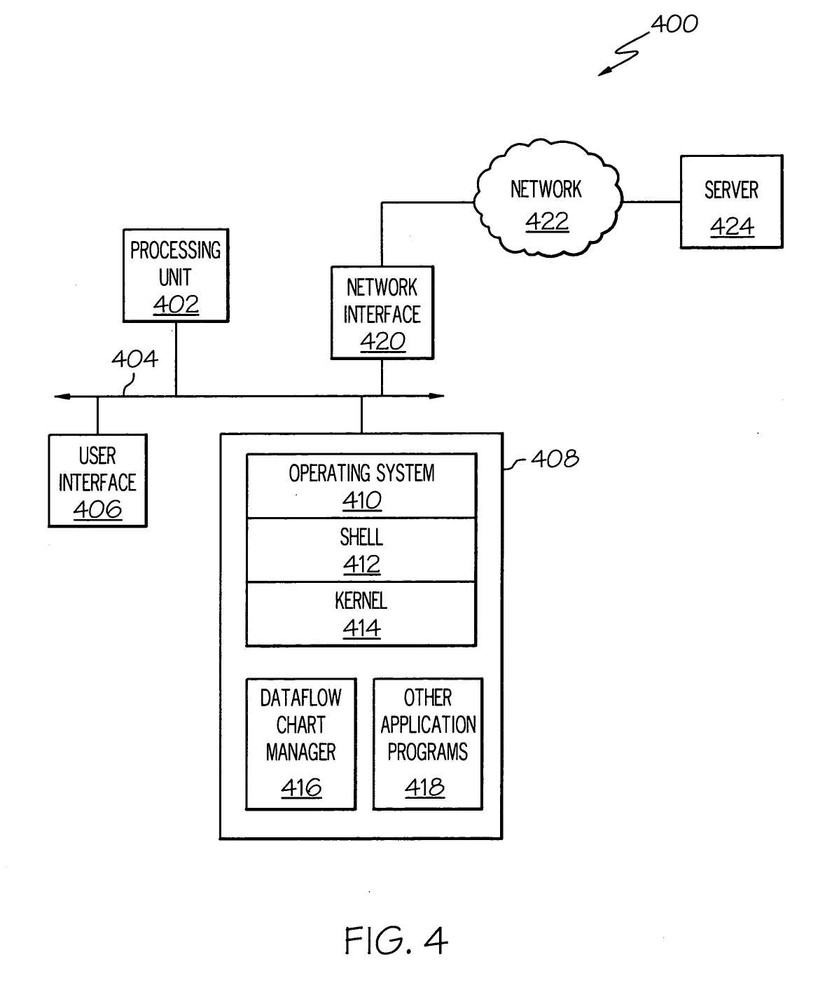

FIG. 4 is a block diagram depicting an exemplary data processing system 400 according to a preferred embodiment of the present invention. As illustrated, data processing system 400 includes processing unit 402, which is coupled to user interface 406 and memory 408 via interconnect 404.

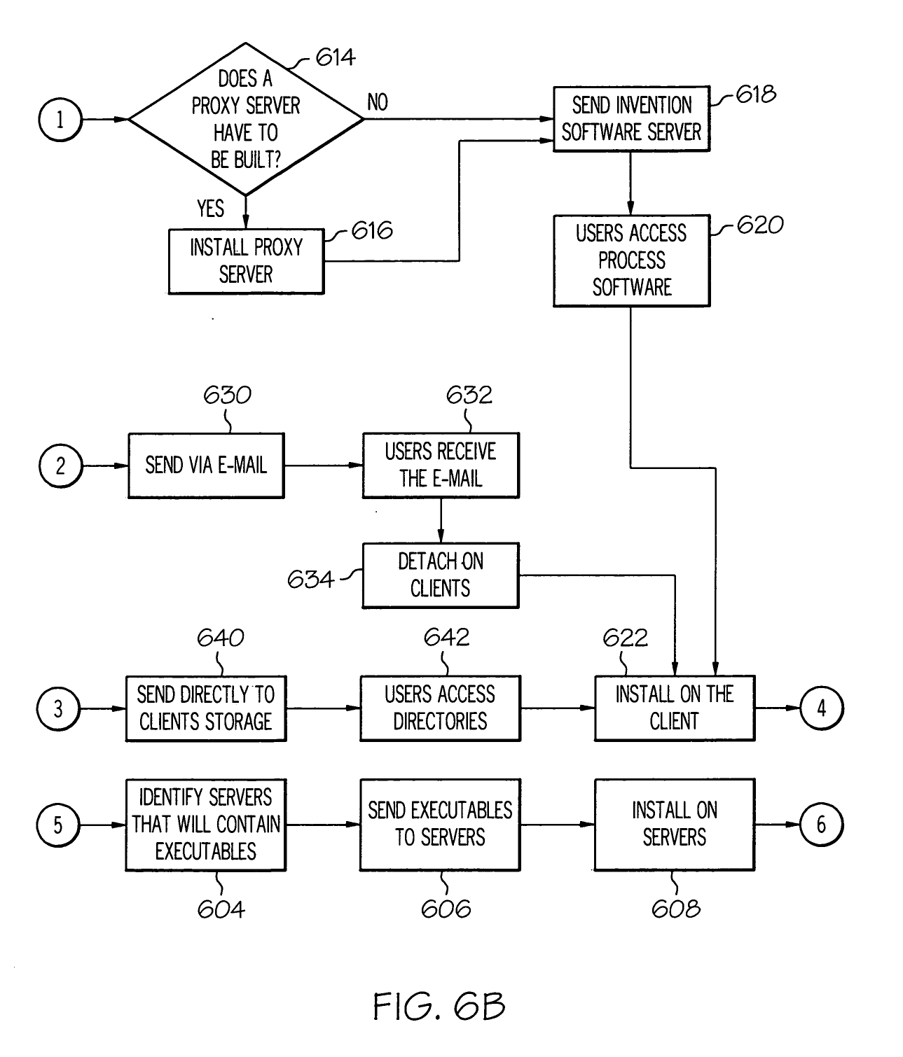

User interface 406 enables a user to access and manipulate data stored in memory 408 and processed by processing unit 402. User interface 406 is implemented by any user interface such as a keyboard, mouse, monitor, touch screen, etc. Memory 408 is implemented by any memory device including, but not limited to: hard disk drives, optical drives, random access memory (RAM), etc. Also coupled to interconnect 404 is network interface 420, which couples data processing system 400 to server 424 via network 422. Server 424 and network 422 are discussed herein in more detail in conjunction with FIGS. 6-9.

As depicted, memory 408 includes operating system 410, which further includes shell 412 for providing transparent user access to resources such dataflow chart manager 416 and other application programs 418. Generally, shell 412 is a program that provides an interpreter and an interface between the user and the operating system. More specifically, shell 412 executes commands that are entered into a command-line user interface or a file. Thus, shell 412 (as it is called in UNIX®), also called a command processor in Windows®, is generally the highest level of the operating system software hierarchy and serves as a command interpreter. The shell provides a system prompt, interprets commands entered by the keyboard, mouse, or other user input media, and sends the interpreted command(s) to the appropriate lower levels of the operating system (e.g., kernel 414) for processing. Note that while shell 412 is a text-based, line-oriented user interface, the present invention will support other user interface modes, such as graphical, voice, gestural, etc. equally well.

As illustrated, operating system 410 also includes kernel 414, which includes lower levels of functionality for operating system 410, including providing essential services required by other parts of operating system 410 including memory management, process and task management, disk management, and mouse and keyboard management.

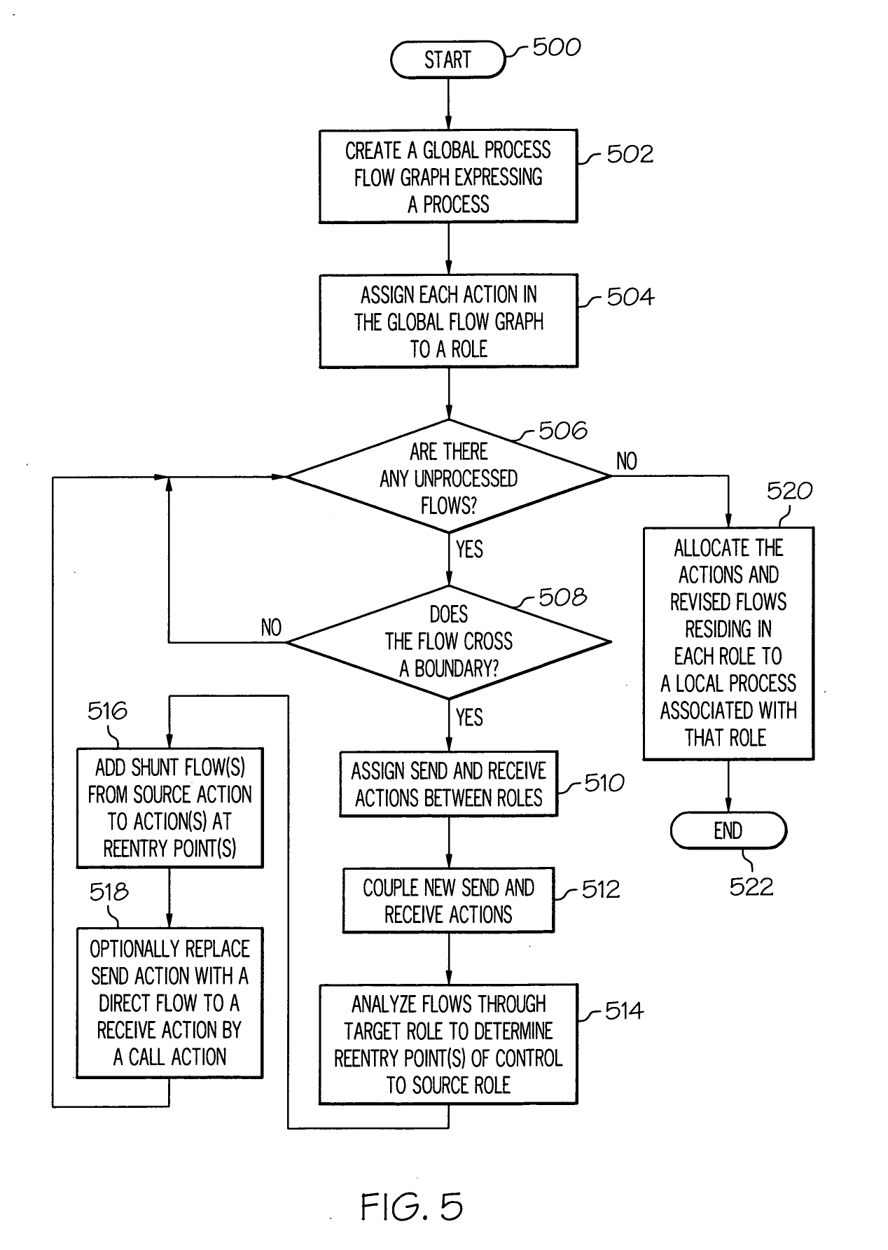

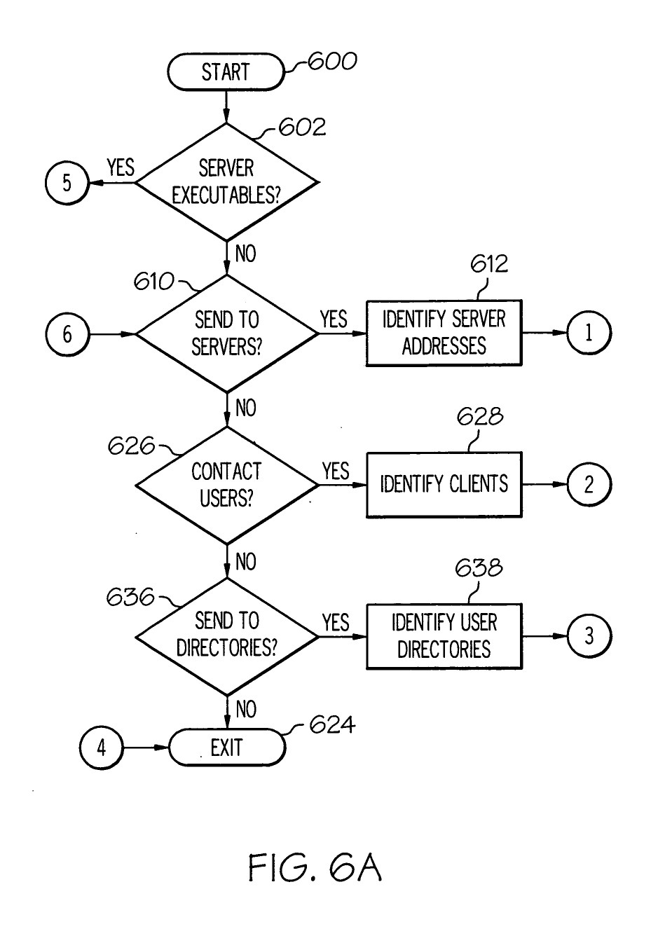

Dataflow chart manager 416 is utilized for the processing and transformation of global process flow graphs (e.g., process flow graphs 100 and 200) to multiple communicating local process flow graphs (e.g., transaction 300) and is discussed herein in more detail in conjunction with FIG. 5. Other application programs 418 can include a browser, utilized for access to the Internet, work processors, spreadsheets and any other application program.

Those of ordinary skill in the art will appreciate that the hardware depicted in FIG. 4 may vary depending on the implementation. Other internal hardware or peripheral devices, such as flash read-only memory (ROM), equivalent non-volatile memory, or optical disk drives and the like, may be utilized in addition or in place of the hardware illustrated in FIG. 4. Also, the processes of the present invention may be applied to a multi-processor data processing system.

The depicted example in FIG. 4 and the above-described examples are not meant to imply architectural limitations. For example, data processing system 400 also may be a notebook computer or hand-held computer in addition to taking the form of a personal digital assistant (PDA). Data processing system 400 also may be a kiosk or a Web appliance.

FIG. 5 is a high-level flowchart diagram illustrating an exemplary method of translating between a global view of a system process and a set of local interacting processes according to a preferred embodiment of the present invention. As described above, a “process flow graph” is a network of actions and flows describing a transaction. The method begins and a global view process flow graph (e.g., process flow graph 100) is constructed utilizing dataflow chart manager 416, as depicted in steps 500 and 502, each action in the process flow graph represents a step in the transaction and the flows between the actions represent sequencing rules. Originally, the process represented by the global view process flow graph is not assigned to any specific object for execution. An exemplary method of translating between a global view of a system process and a set of local interacting processes according to the present invention enables the transformation of a process represented by the global view process flow graph into set of communicating local process flow graphs, each of which is performed by a single role (e.g., transaction 300).

The process continues to step 504, which illustrates dataflow chart manager 416 assigning each action in the global view process flow graph to a role. For example, referring to FIG. 1, actions 102b and 102f may be assigned to a customer role, since theses are actions typically performed by a customer who seeks to book a flight. Actions 102c and 102e (finding potential flights and booking the flight) are assigned to a ticket agent role and the remaining action 102d (checking flight availability) is assigned to an airline role. Information for assignments can be supplied by database entries or derived from specifications of processing hardware or a combination of both.

The process continues to steps 506-516, which depict transforming parts of the global view process flow graph into separate local processes. For each unprocessed flow that crosses a boundary between two roles (steps 506-508), dataflow chart manager 416 cuts the flow at the boundary and inserts a send action (e.g., send actions 312a-d) in the role at the outgoing end, and inserts a receive action (e.g., receive actions 314a-d) in the role at the incoming end (step 510). Dataflow chart manager 416 also inserts a message link 316a-d between each newly inserted pair of send and receive actions (step 512). For example, referring again to FIG. 3, since action 302 (request travel arrangements) in customer role 302a is followed by action 304 (find potential flights) in ticket agent role 302b, send action 312a, receive action 314a, and message 316a are generated to replace the original flow from action 302 to action 304.

Most computer language implementations require that an action must be enabled by a previous action within the same role. In such cases, a flow between each send action and the subsequent receive action or actions that can receive messages as a result of the send action is created by dataflow chart manager 416 by following the chain of cause-and-effect forward through the flow graph until it re-enters the original role (step 514). For example, referring to FIG. 3, a flow 318a between send action 312a and receive action 314d within customer role 302a, and a flow 318b between send action 312b and receive action 314c in ticket agent role 302b, are necessary to enable the receive actions within each role. These flows are called “shunt flows” because they shunt the local control to another action in the same role until the overall global processing eventually returns a message. Shunt flows are not present in the original global process. Therefore, shunt flows (e.g., flows 318a-b) must be generated by dataflow chart manager 416, as depicted in step 516. As an optimization important in many computer languages, a send action followed immediately by a receive action can be optionally replaced by a call action that combines the function of a send action, a shunt flow, and a subsequent receive action into a single special action, as illustrated in step 518.

Returning to step 506, if dataflow chart manager 416 determines that there are no more unprocessed flows, the process continues to step 520, which illustrate dataflow chart manager 416 allocating actions and revised flows residing in each role to a local process associated with that role. The process then ends, as depicted in step 522.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

Software Deployment

As described above, in one embodiment, the processes described by the present invention, including the functions of dataflow chart manager 416, are performed by service provider server 424. Alternatively, dataflow chart manager 416 and the method described herein, and in particular as shown and described in FIG. 5, can be deployed as a process software from service provider server 424 to data processing system 400. Still more particularly, process software for the method so described may be deployed to service provider server 424 by another service provider server (not shown).

Referring then to FIGS. 6a-b, step 600 begins the deployment of the process software. The first thing is to determine if there are any programs that will reside on a server or servers when the process software is executed (query block 602). If this is the case, then the servers that will contain the executables are identified (block 604). The process software for the server or servers is transferred directly to the servers' storage via File Transfer Protocol (FTP) or some other protocol or by copying though the use of a shared file system (block 606). The process software is then installed on the servers (block 608).

Next, a determination is made on whether the process software is to be deployed by having users access the process software on a server or servers (query block 610). If the users are to access the process software on servers, then the server addresses that will store the process software are identified (block 612).

A determination is made if a proxy server is to be built (query block 614) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 616). The process software is sent to the servers either via a protocol such as FTP or it is copied directly from the source files to the server files via file sharing (block 618). Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems (block 620). Another embodiment is to have the servers automatically copy the process software to each client and then run the installation program for the process software at each client computer. The user executes the program that installs the process software on his client computer (block 622) then exits the process (terminator block 624).

In query step 626, a determination is made whether the process software is to be deployed by sending the process software to users via e-mail. The set of users where the process software will be deployed are identified together with the addresses of the user client computers (block 628). The process software is sent via e-mail to each of the users' client computers (block 630). The users then receive the e-mail (block 632) and then detach the process software from the e-mail to a directory on their client computers (block 634). The user executes the program that installs the process software on his client computer (block 622) then exits the process (terminator block 624).

Lastly a determination is made on whether the process software will be sent directly to user directories on their client computers (query block 636). If so, the user directories are identified (block 638). The process software is transferred directly to the user's client computer directory (block 640). This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software (block 642). The user executes the program that installs the process software on his client computer (block 622) and then exits the process (terminator block 624).

VPN Deployment

The present software can be deployed to third parties as part of a service wherein a third party VPN service is offered as a secure deployment vehicle or wherein a VPN is build on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling which is the process of placing an entire packet within another packet and sending it over a network. The protocol of the outer packet is understood by the network and both points, called runnel interfaces, where the packet enters and exits the network.

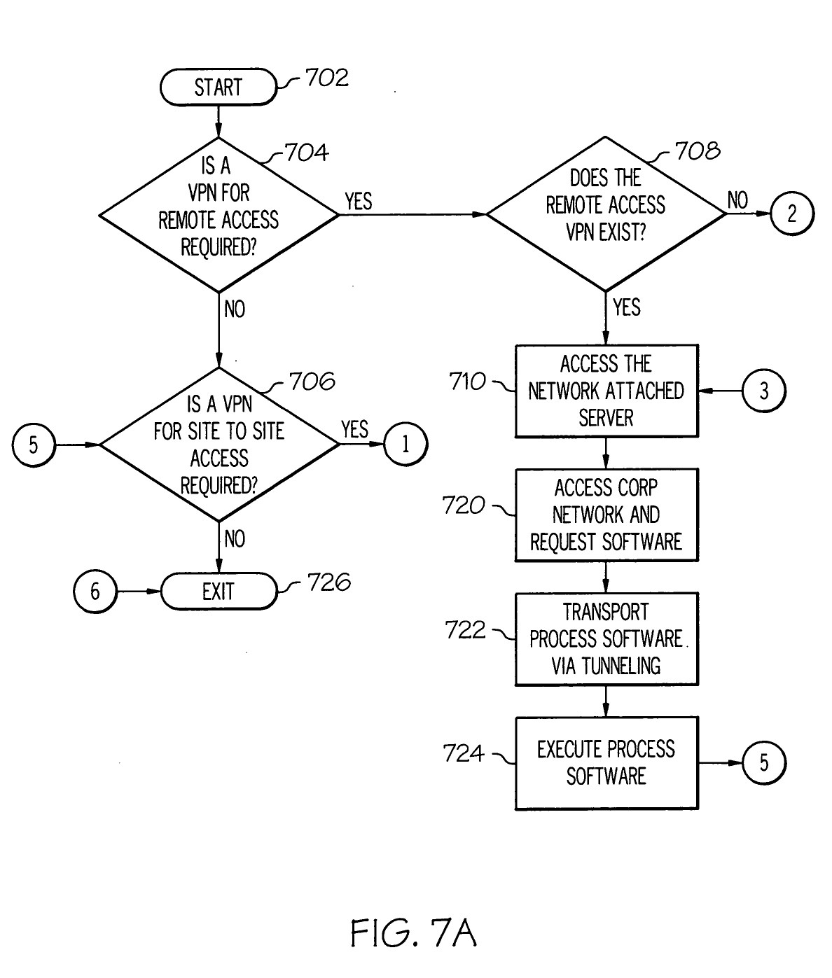

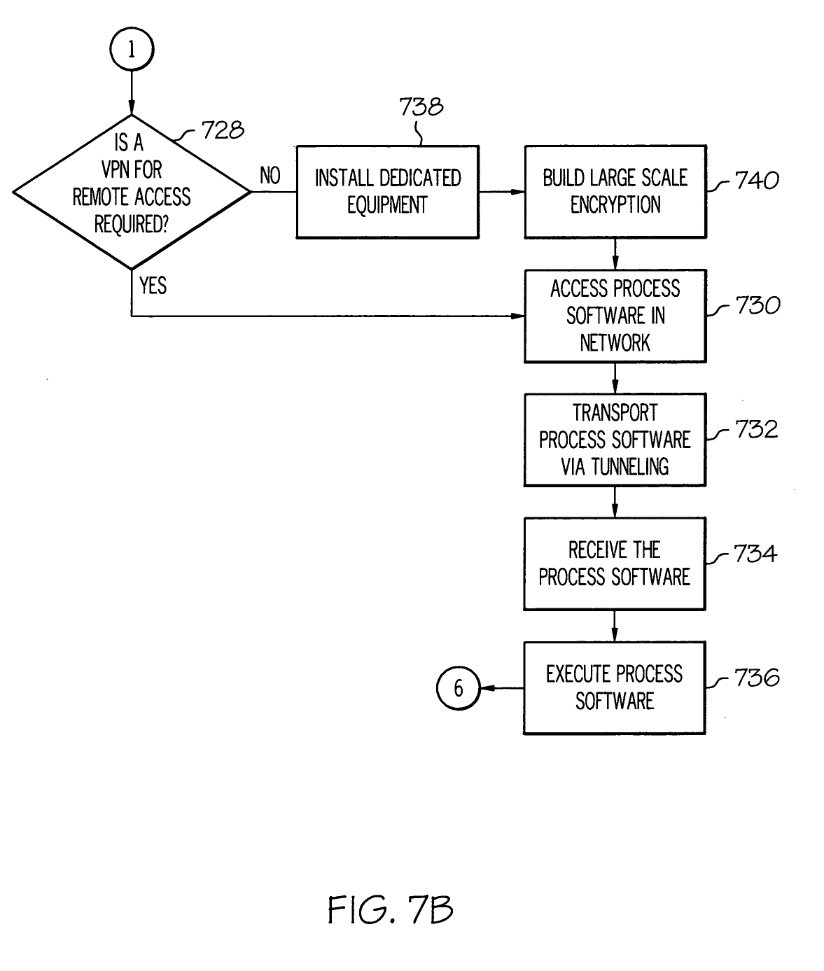

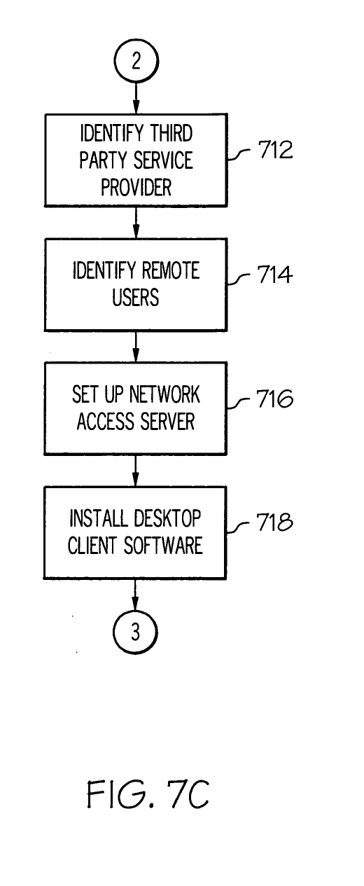

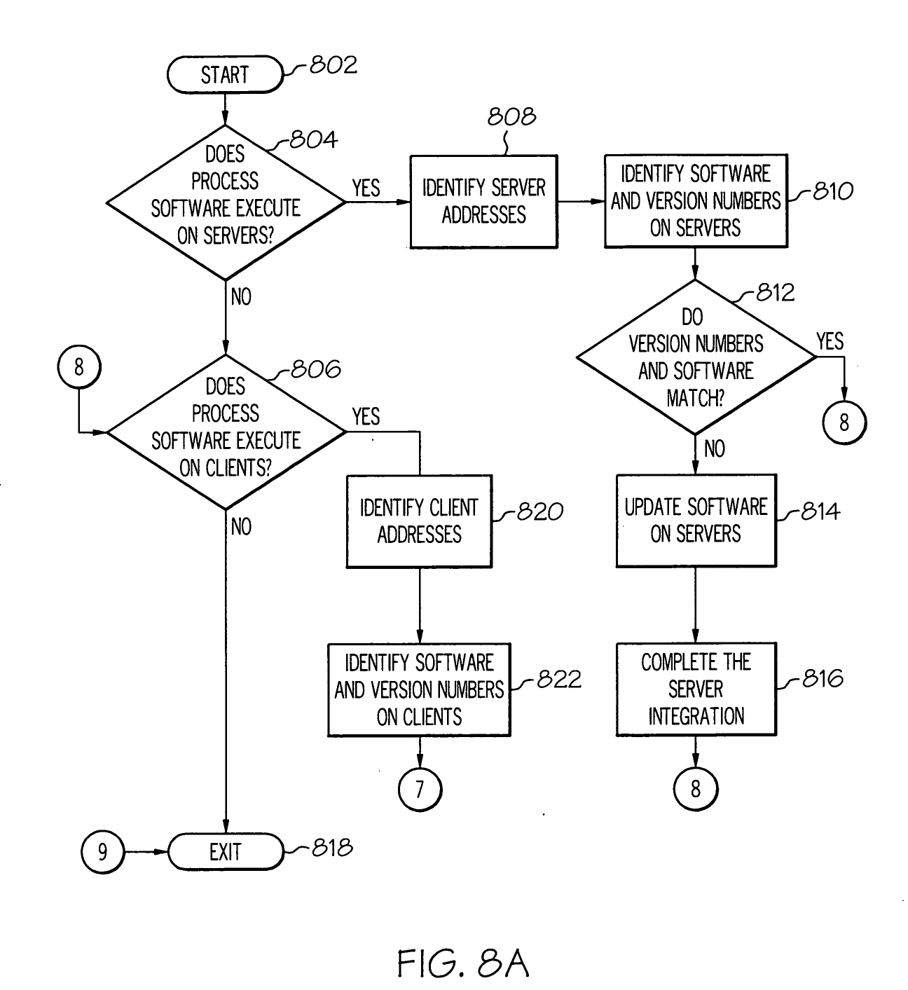

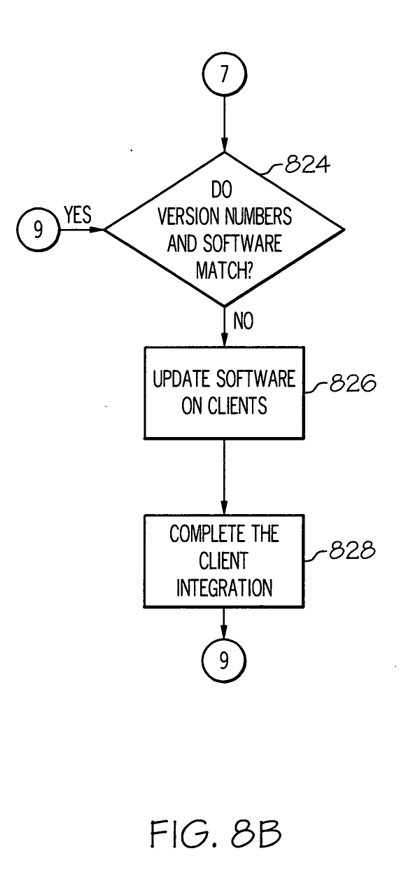

The process for such VPN deployment is described in FIGS. 7a-c. Initiator block 702 begins the Virtual Private Network (VPN) process. A determination is made to see if a VPN for remote access is required (query block 704). If it is not required, then proceed to (query block 706). If it is required, then determine if the remote access VPN exists (query block 708).

If a VPN does exist, then proceed to block 710. Otherwise identify a third party provider that will provide the secure, encrypted connections between the company's private network and the company's remote users (block 712). The company's remote users are identified (block 714). The third party provider then sets up a network access server (NAS) (block 716) that allows the remote users to dial a toll free number or attach directly via a broadband modem to access, download and install the desktop client software for the remote-access VPN (block 718).

After the remote access VPN has been built or if it been previously installed, the remote users can access the process software by dialing into the NAS or attaching directly via a cable or DSL modem into the NAS (block 710). This allows entry into the corporate network where the process software is accessed (block 720). The process software is transported to the remote user's desktop over the network via tunneling. That is the process software is divided into packets and each packet including the data and protocol is placed within another packet (block 722). When the process software arrives at the remote user's desk-top, it is removed from the packets, reconstituted and then is executed on the remote users desk-top (block 724).

A determination is then made to see if a VPN for site to site access is required (query block 706). If it is not required, then proceed to exit the process (terminator block 726). Otherwise, determine if the site to site VPN exists (query block 728). If it does exist, then proceed to block 730. Otherwise, install the dedicated equipment required to establish a site to site VPN (block 738). Then build the large scale encryption into the VPN (block 740).

After the site to site VPN has been built or if it had been previously established, the users access the process software via the VPN (block 730). The process software is transported to the site users over the network via tunneling (block 732). That is the process software is divided into packets and each packet including the data and protocol is placed within another packet (block 734). When the process software arrives at the remote user's desktop, it is removed from the packets, reconstituted and is executed on the site users desk-top (block 736). The process then ends at terminator block 726.

Software Integration

The process software which consists code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists match the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

For a high-level description of this process, reference is now made to FIGS. 8a-b. Initiator block 802 begins the integration of the process software. The first tiling is to determine if there are any process software programs that will execute on a server or servers (block 804). If this is not the case, then integration proceeds to query block 806. If this is the case, then the server addresses are identified (block 808). The servers are checked to see if they contain software that includes the operating system (OS), applications, and network operating systems (NOS), together with their version numbers, which have been tested with the process software (block 810). The servers are also checked to determine if there is any missing software that is required by the process software in block 810.

A determination is made if the version numbers match the version numbers of OS, applications and NOS that have been tested with the process software (block 812). If all of the versions match and there is no missing required software the integration continues in query block 806.

If one or more of the version numbers do not match, then the unmatched versions are updated on the server or servers with the correct versions (block 814). Additionally, if there is missing required software, then it is updated on the server or servers in the step shown in block 814. The server integration is completed by installing the process software (block 816).

The step shown in query block 806, which follows either the steps shown in block 804, 812 or 816 determines if there are any programs of the process software that will execute on the clients. If no process software programs execute on the clients the integration proceeds to terminator block 818 and exits. If this not the case, then the client addresses are identified as shown in block 820.

The clients are checked to see if they contain software that includes the operating system (OS), applications, and network operating systems (NOS), together with their version numbers, which have been tested with the process software (block 822). The clients are also checked to determine if there is any missing software that is required by the process software in the step described by block 822.

A determination is made if the version numbers match the version numbers of OS, applications and NOS that have been tested with the process software (query block 824). If all of the versions match and there is no missing required software, then the integration proceeds to terminator block 818 and exits.

If one or more of the version numbers do not match, then the unmatched versions are updated on the clients with the correct versions (block 826). In addition, if there is missing required software then it is updated on the clients (also block 826). The client integration is completed by installing the process software on the clients (block 828). The integration proceeds to terminator block 818 and exits.

On Demand

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

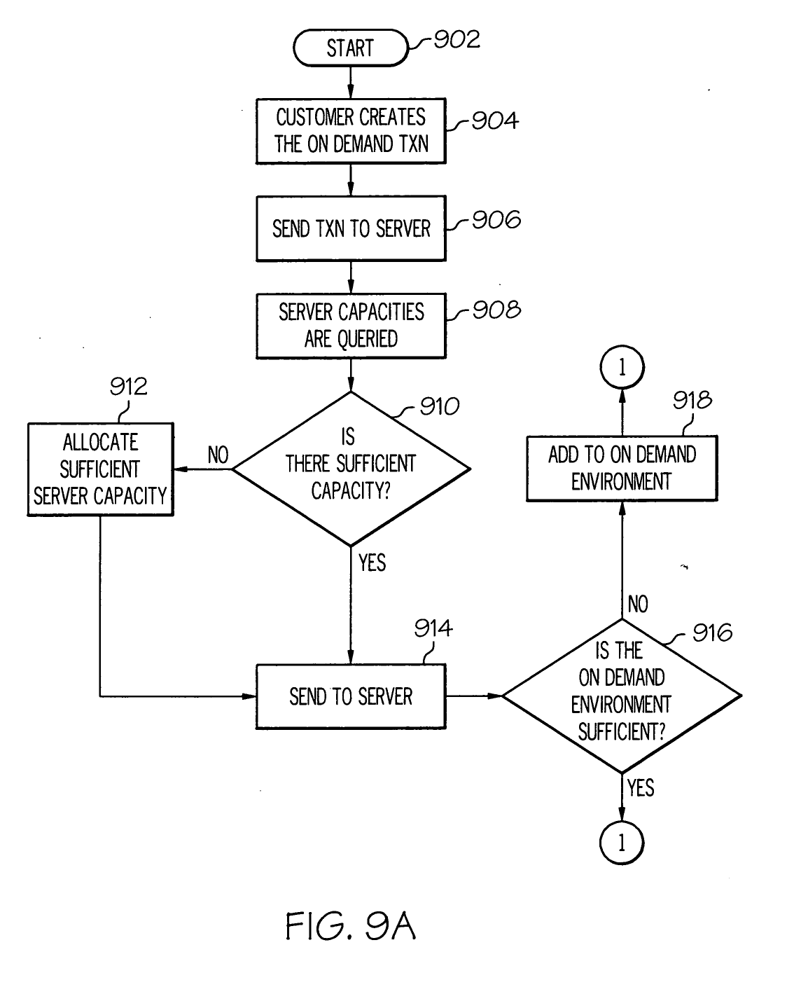

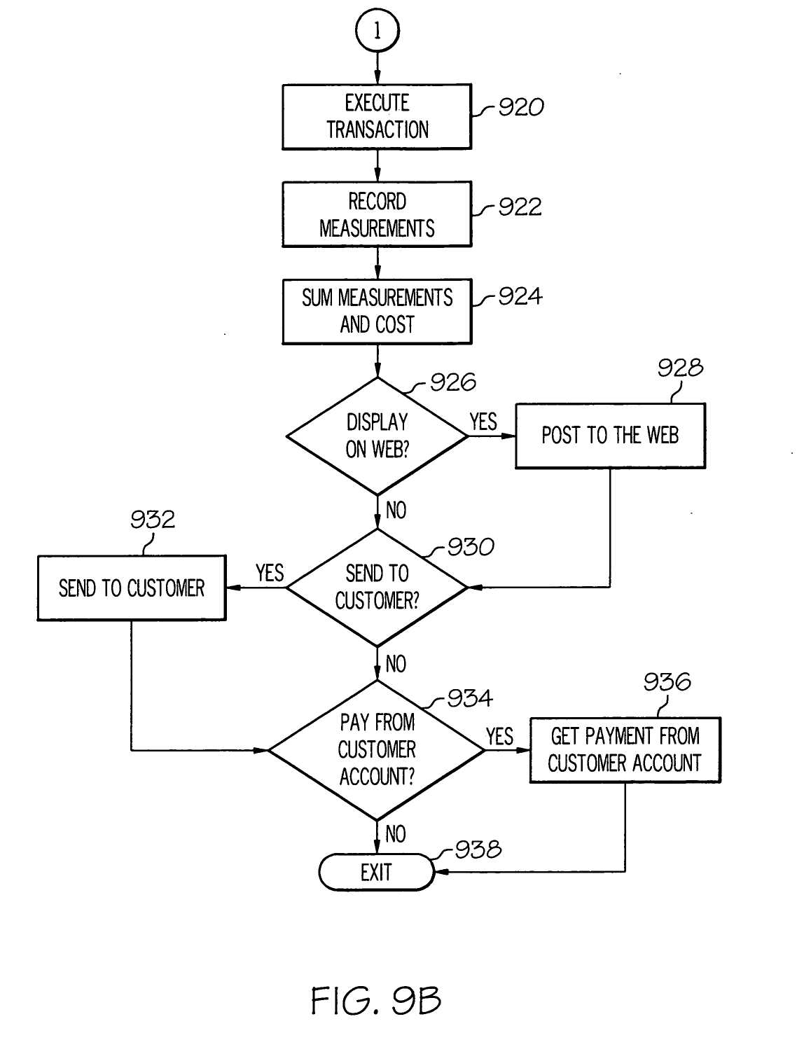

With reference now to FIGS. 9a-b, initiator block 902 begins the On Demand process. A transaction is created than contains the unique customer identification, the requested service type and any service parameters that further, specify the type of service (block 904). The transaction is then sent to the main server (block 906). In an On Demand environment the main server can initially be the only server, then as capacity is consumed other servers are added to the On Demand environment.

The server central processing unit (CPU) capacities in the On Demand environment are queried (block 908). The CPU requirement of the transaction is estimated, then the servers available CPU capacity in the On Demand environment are compared to the transaction CPU requirement to see if there is sufficient CPU available capacity in any server to process the transaction (query block 910). If there is not sufficient server CPU available capacity, then additional server CPU capacity is allocated to process the transaction (block 912). If there was already sufficient Available CPU capacity then the transaction is sent to a selected server (block 914).

Before executing the transaction, a check is made of the remaining On Demand environment to determine if the environment has sufficient available capacity for processing the transaction. This environment capacity consists of such things as but not limited to network bandwidth, processor memory, storage etc. (block 916). If there is not sufficient available capacity, then capacity will be added to the On Demand environment (block 918). Next the required software to process the transaction is accessed, loaded into memory, then the transaction is executed (block 920).

The usage measurements are recorded (block 922). The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 924).

If the customer has requested that the On Demand costs be posted to a web site (query block 926), then they are posted (block 928). If the customer has requested that the On Demand costs be sent via e-mail to a customer address (query block 930), then these costs are sent to the customer (block 932). If the customer has requested that the On Demand costs be paid directly from a customer account (query block 934), then payment is received directly from the customer account (block 936). The On Demand process is then exited at terminator block 938.

As discussed, the present invention includes a method, apparatus, and computer-usable medium for graphically depicting a behavior as a global process flow graph, wherein the global process flow graph includes a collection of actions performed by at least two roles; and transforming the global process flow graph into a collection of local processes, wherein each local process includes actions performed by a first role.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system include, but not limited to, personal computers, servers, workstations, network computers, main frame computers, routers, switches, Personal Digital Assistants (PDAs), telephones, and any other system capable of processing, transmitting, receiving, capturing, and/or storing data.

What is claimed is:

1. A computer-implementable method comprising:
graphically depicting a behavior as a global process flow graph, wherein said global process flow graph includes a plurality of actions performed by at least two roles; and
transforming said global process flow graph into a plurality of local processes, wherein each local process includes actions performed by each role among said at least two roles.

2. The computer-implementable method according to claim 1, wherein said transforming further includes:
assigning each action among said plurality of actions to said at least two roles;
determining if at least one flow between said plurality of actions cross a boundary between said at least two roles;
replacing said at least one flow with a plurality of explicit communication actions at said at least two roles; and
adding a plurality of additional flows within said at least two roles to represent cause-and-effect paths that departed from a first role and subsequently re-entered said first role in said global process flow graph.

3. The computer-implementable method according to claim 2, wherein said plurality of explicit communication actions further include at least one send action, at least one receive action, and at least one message.

4. The computer-implementable method according to claim 2, wherein said plurality of explicit communication actions further include at least one call action.

5. A system comprising:
a processor;
a data bus coupled to said processor;
a computer-usable medium embodying computer program code, said computer-usable medium being coupled to said data bus, said computer program code comprising instructions executable by said processor and configured for:
graphically depicting a behavior as a global process flow graph, wherein said global process flow graph includes a plurality of actions performed by at least two roles; and
transforming said global process flow graph into a plurality of local processes, wherein each local process includes actions performed by each role among said at least two roles.

6. The system according to claim 5, wherein said instructions for transforming are further configured for:
assigning each action among said plurality of actions to said at least two roles;
determining if at least one flow between said plurality of actions cross a boundary between said at least two roles;
replacing said at least one flow with a plurality of explicit communication actions at said at least two roles; and
adding a plurality of additional flows within said at least two roles to represent cause-and-effect paths that departed from a first role and subsequently re-entered said first role in said global process flow graph.

7. The system according to claim 6, wherein said plurality of explicit communication actions further include at least one send action, at least one receive action, and at least one message.

8. The system according to claim 6, wherein said plurality of explicit communication actions further include at least one call action.

9. A computer-usable medium embodying computer program code, said computer program code comprising computer-executable instructions configured for:
graphically depicting a behavior as a global process flow graph, wherein said global process flow graph includes a plurality of actions performed by at least two roles; and
transforming said global process flow graph into a plurality of local processes, wherein each local process includes actions performed by each role among said at least two roles.

10. The computer-usable medium according to claim 9, wherein said instructions for transforming further comprises computer-executable instructions configured for:
assigning each action among said plurality of actions to said at least two roles;
determining if at least one flow between said plurality of actions cross a boundary between said at least two roles;
replacing said at least one flow with a plurality of explicit communication actions at said at least two roles; and
adding a plurality of additional flows within said at least two roles to represent cause-and-effect paths that departed from a first role and subsequently re-entered said first role in said global process flow graph.

11. The computer-usable medium according to claim 10, wherein said plurality of explicit communication actions further include at least one send action, at least one receive action, and at least one message.

12. The computer-usable medium according to claim 10, wherein said plurality of explicit communication actions further include at least one call action.

13. The computer-usable medium according to claim 9, wherein the computer executable instructions are deployable to a client computer from a server at a remote location.

14. The computer-usable medium according to claim 9, wherein the computer-executable instructions are provided by a service provider to a customer on an on-demand basis.
